(19) United States
(12) Patent Application Publication
(10) Pub. No.: US 2014/0144245 A1
(43) Pub. Date: May 29, 2014

(54) PLANAR HIGH VOLTAGE TRANSFORMER

(71) Applicant: GE Medical Systems Global Technology Company, LLC, Waukesha, WI (US)

(72) Inventors: Jianhai Zhang, Beijing (CN); Wei Lin, Beijing (CN); Qiang Cheng, Beijing (CN)

(73) Assignee: GE Medical Systems Global Technology Company, LLC, Waukesha, WI (US)

(21) Appl. No.: 14/082,539

(22) Filed: Nov. 18, 2013

(30) Foreign Application Priority Data
Nov. 23, 2012 (CN) 201210483640.3

(51) Int. Cl. G01L 1/00

(52) U.S. Cl. CPC G01L 1/005
USPC 73/774

(57) ABSTRACT

A curved surface shaped membrane pressure sensor for a moving member and the method for manufacturing the same, the sensor comprising an elastic curved plate and a subtype grid membrane switch formed on the curved plate, wherein the membrane switch is coupled to a cutting board shell of the moving member on one side opposed to the curved plate, and the subtype grid membrane switch is used for sensing the presence of pressure on the curved plate. The curved surface shaped membrane pressure sensor according to the present invention can not only meet the requirements on appearance of the moving member, but also effectively sense the touching to prevent injury on the object being detected, and additionally can effectively achieving the effects of fireproofing and waterproofing.

### TECHNICAL FIELD

The present application generally relates to the field of membrane pressure sensors, and more particularly, to a curved surface shaped membrane pressure sensor for a moving member and method for manufacturing the same.

### BACKGROUND OF THE INVENTION

In recent years, membrane pressure sensors are widely applied in the industry because of their advantages such as high stability, small volume, and high reliability. A membrane pressure sensor is generally regarded as an ultrathin multi-layer electromechanical device, having an electrode and a connecting wire arranged in order on a sensing element and its lamination structure, and using a suitable polymer membrane and epoxy resin material to make a solid ultrathin packaging structure. When the membrane pressure sensor is subjected to a sudden contact pressure or a continuously changing pressure, pull or velocity field, an electrical signal would be produced for outputting a corresponding indication and/or actuating control and operations of the machine. Generally speaking, the membrane pressure sensor includes four typical applications, namely, electric switch, impact pressure, strain, and measurement of object velocity. Based on the above typical applications, the membrane sensor can be classified into four types, namely, switch, pressure meter, strain gauge, and electromagnetic speedmeter. It is further well known in the art that the operating principle of the four types of membrane sensors depends upon four different physical effects—a sudden electric contact (switch), gradual electrical resistance change under a pressure (compressive resistance) or a strain (tensile resistance), gradual charge release under a pressure (piezodielectricity) or a strain (tensile electricity), and an electromotive force (electromotive force speed effect) produced around a conductor when the conductor moves into a magnetic field.

Additionally, persons skilled in the art have been seeking a further improvement on the membrane pressure sensor. For example, a Chinese patent application No. 03123715.0 (publication No. CN1460846A, published on Dec. 10, 2003) entitled “Semiconductor Pressure Sensor of Film Type” filed on May 20, 2003 discloses a semiconductor pressure sensor, whose dimension is reduced but sensibility is not significantly decreased, such that necessary sensibility and reliability can be ensured while reducing the cost.

In addition, there also exist a plurality of methods for manufacturing a membrane pressure sensor in the art. For example, a Chinese patent application No. 200610105162.7 (publication No. CN1975358A, published on Jun. 6, 2007) entitled “Low-temperature Film Pressure Sensor and Producing Method thereof” filed on Dec. 14, 2006 discloses a low-temperature film pressure sensor and its manufacturing method. This invention can provide a self-compensating low-temperature film pressure sensor in the film by arranging a compensating resistance layer between a strain resistance layer and a terminal pad layer, so as to more precisely measure the pressure at a low-temperature medium.

Finally, there also exist technologies for applying a membrane pressure sensing element to a special part of industrial equipment (e.g. medical instrument), For example, a Chinese patent application No. 201110246486.3 (publication No. CN102423269A, published on Apr. 25, 2012) entitled “Catheter with Thin Film Pressure Sensing Distal Tip” filed on Aug. 16, 2011 discloses a catheter having contact force sensing capabilities at a distal end. Specifically, the invention applies a thin film pressure sensor that has two opposing flexible and thin support members to a tip electrode at a distal tip section so as to detect a force vector applied to the tip electrode.

Accordingly, what is well-known in the art is the use of an effective way to manufacture a thin film pressure sensor, and apply it to industrial equipment such as medical instrument, so that the industrial equipment has desired properties (e.g., the capability of sensing physical quantities such as contact force at certain location).

However, in many industrial equipment such as computerized tomography (CT) or magnetic resonance medical equipment, there usually exists a moving member having a large force (i.e., a large momentum generated by the rotation, movement, and translation) when working and having design requirements. On one hand, the moving member may have any desired and/or customized appearance and shape, which restricts the application of a conventional plane film pressure sensor; on the other hand, if the pressure sensor/pressure switching element cannot be properly superimposed to said moving member, for example, if the goodness of fit between the moving member and the pressure sensor is relatively poor or there exists a relatively large pressure-sensitive blind zone, when the moving member touches even impacts target subjects (e.g., patients, target animals), since a control system of the moving member cannot know the situation in time and make a necessary processing (for example, start a circuit breaker to command the moving member to stop or perform other protection measures for controlling operations of the moving member), an injury or even death may be caused for the object.

Similar problems also exist in apparatuses for detecting, for example, baggage and industrial parts. For example, if a control system for detecting a moving member of an apparatus can not be promptly informed of the impact on the objects being detected such as baggage or industrial parts by the moving member, it can not promptly make a necessary command to stop the moving member, so the objects being detected may be damaged; sometimes the detection apparatus will be bruised by the objects being detected.

Further, since membrane switches are typically very sensitive, for example, 0.5 N or even less force can make it to respond, a single thin film pressure sensor may make an erroneous judgment in the use due to machine vibration or other undesired reasons, and thereby mistriggering a control system of a moving member, resulting in an unnecessary downtime of the whole system and loss of time and money.

Therefore, it is desired to install an improved thin film pressure sensor in a moving member of industrial equipment, which can ensure the safety of objects being detected and industrial equipment in the case of reaching a certain appearance requirements and will not cause too many false triggering.

### BRIEF SUMMARY OF THE INVENTION

To solve the above and other technical problems, the invention provides a curved surface shaped membrane pressure sensor and method for manufacturing the same.

According to an embodiment, there is provided a curved surface shaped membrane pressure sensor for a moving member, comprising an elastic curved plate and a subtype grid membrane switch formed on the curved plate, wherein the membrane switch is coupled to a cutting board shell of the moving member on one side opposed to the curved plate, and the subtype grid membrane switch is used for sensing the presence of pressure on the curved plate.

According to an embodiment, there is provided a method for forming a curved surface shaped membrane pressure sensor on a moving member, comprising: forming an elastic curved plate based on a method for machining a plate; forming a subtype grid membrane switch on the curved plate using subtyping technologies and flat printing technology; and coupling the subtype grid membrane switch to a cutting board shell of the moving member on one side opposed to the curved plate. The subtype grid membrane switch is used for sensing the presence of pressure on the curved plate.

Thin film pressure sensors can be effectively applied to a wider field of curved surface by using the curved surface shaped membrane pressure sensor as disclosed, moreover, the factoring is easy and the cost is low. It can meet the requirements of the appearance of a moving member, and can effectively sense touching to avoid injury on objects being detected, and additionally is effectively fireproofing and waterproofing because of shape integrity of the appearance of the sensor.

### BRIEF DESCRIPTION OF THE DRAWINGS

When reading the following detailed description with reference to the accompanying drawings (not necessarily drawn to scale), these and other features, aspects and advantages of the invention will be better understood. In the drawings, a similar sign represents a similar part, in which:

FIG. 1 is a perspective view of a curved surface shaped membrane pressure sensor;

FIG. 2 is a wiring structure of a membrane switch conductive layer according to an embodiment of the present application;

FIG. 3 is a diagram illustrating pressure deformation of the curved surface shaped membrane pressure sensor; and

FIG. 4 is a flow chart for manufacturing a curved surface shaped membrane pressure sensor of an embodiment of the present application.

### DETAILED DESCRIPTION OF THE INVENTION

One or more specific embodiments of a curved surface shaped membrane pressure sensor will be described hereinafter. In order to provide a concise description of these embodiments, not all the features actually implemented are described in the specification. Should be understood that in any implementation development, for example, in any engineering or design project, many special decisions shall be made to achieve the developer's goals, for example, to comply with system-associated and traffic-associated constraints, which may vary between implementations. Should be further realized that such a development effort might be complex and time consuming, but it is still the routine task of design, production and manufacturing for those of ordinary skills benefiting from the disclosure of the present application.

When introducing elements of various embodiments of the subject matter of the present application, the articles “a” “the” and “said” are intended to mean that there are one or more elements. The terms “comprising”, “including” and “having” are intended to be inclusive and mean that there may he additional elements other than the listed elements. In addition, although the term “exemplary” as used herein can be combined with the presently disclosed technology aspects or some examples in the embodiments for use, it should be appreciated that these examples are illustrative in nature and that the term “exemplary” is not used herein to indicate any preferences or requirements on the aspects or embodiments disclosed in the present application.

FIG. 1 is an example of a curved surface shaped membrane pressure sensor 10. As shown in FIG. 1, a moving member (not shown, for example, a moving member of industrial equipment) needs to add the curved surface shaped membrane pressure sensor 10 to sense the surface pressure, thereby protecting objects being detected from damage; on the other hand, the moving member may have any shape as required, so a curved plate (a part of the curved plate is shown by reference sign 1) of the corresponding curved surface shaped membrane pressure sensor 10 is also configured as, for example, a curved shape shown in FIG. 1. As shown, the center of the curved plate 1 is hollow or is transparent-window treated, so as to expose, for example, a button, control means, display means on the moving member, and the user can control/manipulate the operations of the moving member and the other components coupled to the moving member and/or monitor their working conditions by manipulating these components.

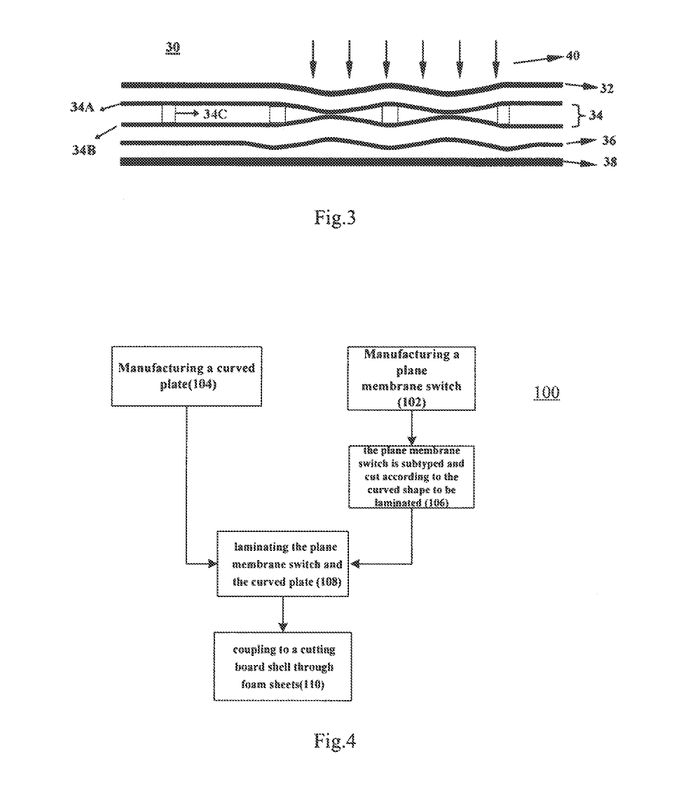

The curved surface shaped membrane pressure sensor 10 adds a membrane switch, foam and the like on other parts than part 1 of the curved plate, which is completed by using a method 100 (see FIG. 4) in combination with the subtyping technology described in more detail below; the final curved surface shaped membrane pressure sensor 10 is laminated onto a moving member curved surface of the moving member (shown in FIG. 3). A part of the curved surface shaped membrane pressure sensor laminated onto a specific curved surface is generally shown by reference sign 12. Additionally, FIG. 1 further gives a subtyping and cutting manner 14 of foam and a membrane switch, which can improve the coverage of the membrane switch and the foam on the curved plate, i.e., can improve the duty ratio of the sensor, while laminating the membrane switch and the foam onto the elastic curved plate better, so that the curved surface shaped membrane pressure sensor 12, as a whole, can sense the touching pressure from outside more effectively.

The person skilled in the art, by combining FIG. 1 and FIG. 3 to read the present disclosure, can realize that a moving member laminated with the curved surface shaped membrane pressure sensor 12 is capable of sensing the pressure on the curved surface with a smaller pressure sensing blind zone, while the moving member seems not to be affected by the laminated curved surface shaped membrane pressure sensor 12 substantially. Further, choosing a suitable material to make the curved surface shaped membrane pressure sensor 12 and making it to cover the outer surface of the moving member completely can further achieve the technical effects of preventing false triggering, fireproofing and waterproofing to a certain extent.

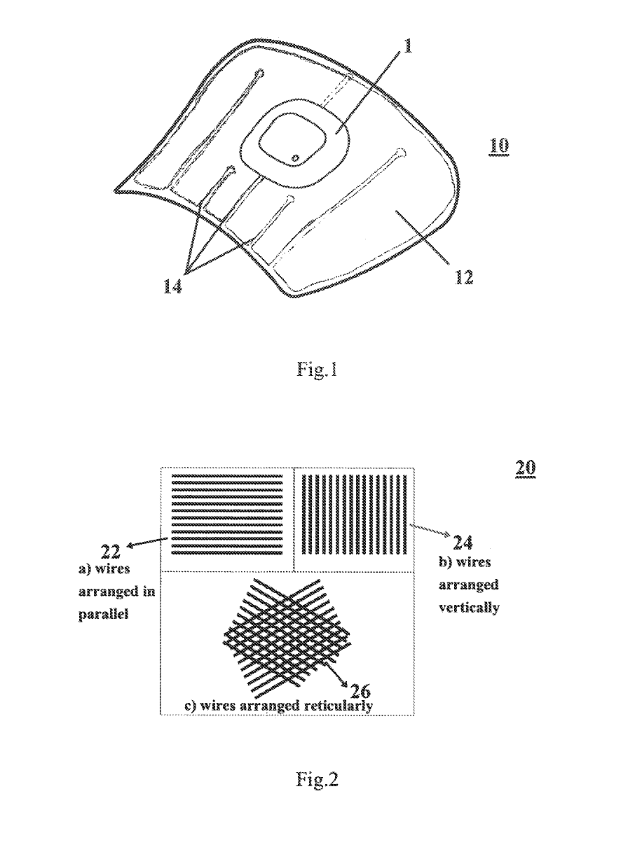

FIG. 2 shows several wiring structures of a membrane switch conductive layer (for example, an upper grid membrane and a lower grid membrane 34A and 34B as shown in FIG. 3) of an embodiment according to the present application. Skilled in the art are aware that one or more of the wiring structures can be chosen as required and the chosen wiring structures are respectively used in the upper grid membrane and the lower grid membrane 34A and 34B further described in combination with FIG. 3. For example, FIG. 2a) illustrates wires 22 arranged in parallel; FIG. 2b) illustrates wires 24 arranged vertically; and FIG. 2c) illustrates wires 26 arranged reticularly. When an external pressure is transmitted through a curved plate 32 to a membrane switch 34 (both seen in FIG. 3), the upper grid membrane and the lower grid membrane 34A and 34B of the membrane switch 34 progressively transfer the pressure and generate corresponding deformation of extrusion, causing the upper and lower grid membranes shorting, resulting in impedance of the grids or impedance between the grids changed. By measuring, receiving, and analyzing the impedance changes, an analysis device (e.g., a microprocessor, a computer, etc., not shown) connected to the wires is able to determine the stress of the moving member (which means that the moving member is in contact with the object being detected), and to further perform a control processing, for example, to stop the movement of the moving member.

Those skilled in the art understand that the arrangements of wires are merely exemplified. According to actual needs, combinations of said three arrangements and other common arrangements can be selected to lay out wires, which will not exceed the scope of disclosure contained in the present application.

Referring to FIG. 3 and in combination with an exemplary embodiment 30 of a curved surface shaped membrane pressure sensor, the principle of the present application is described in details. Since the relative positional relationship between components of the curved surface shaped membrane pressure sensor depends on the observer's location, the terms “top” , “bottom”, “upper”, “lower”, “above”, “below”, and the like used herein for describing the positional relationship between two components are relative, and when observed in place, the positional relationship between the both may be reversed. In other words, any use of any positional terms and variations of these terms is made for convenience, and the components as described are not required to have any orientation.

FIG. 3 schematically shows a curved surface shaped membrane pressure sensor 30 incorporated with a membrane switch 34. According to an embodiment, the curved surface shaped membrane pressure sensor 30 includes a curved plate 32, a membrane switch 34 attached to the curved plate, and foam 36 located below the membrane switch. In installation, the side of the curved plate 32 is taken as an appearance face (i.e., the face that can be seen from the outside after installation), and the side of the foam 36 of the membrane switch 34 fits into a cutting board shell 38 of the moving member. The main components will be hereinafter described in more details.

Generally, the curved plate 32 as a pressure receiving surface may be machined by using a variety of methods for machining plates into a variety of relatively complex complete shapes, not limited to simple planar graphs, which largely facilitates product appearance and functionality design. According to several embodiments, the curved plate 32 is integrally formed, and its appearance is more aesthetic; the performances of waterproofing, fireproofing and even chemical resistance of the curved surface shaped membrane pressure sensor 30 may be enhanced by selecting the material of the curved plate 32; and the overall sensitivity of the curved surface shaped membrane pressure sensor can be changed by changing the mechanical property of the material and thickness of the curved plate 32. For example, the material and the thickness of the curved plate 32 are selected as deforming when the received pressure reaches some pressure threshold, the pressure may be caused by the contacting of the moving member with the object being detected. In an embodiment, the pressure threshold is 0.5 N, 1 N, 10 N, 30 N. In an embodiment, the pressure is between 10 N and 40 N.

The skilled person will realize that the features may be applied alone, or in combination with applications if possible to obtain different products. In short, the shape of the curved plate 32 can be selected according to appearance design requirements of the moving member (not shown), for example, the curved plate 32 is a curved shape as shown in FIG. 1, and is, in an embodiment, made from an elastic material, i.e., is an elastic curved plate 32. According to an embodiment, when a suitable pressure 40 (e.g., between 10-40 Newtons) is applied to the curved plate, since the curved plate is elastic, it may deform and transfer the pressure downwardly to the membrane switch 34, as schematically shown in FIG. 3.

The membrane switch 34 can be made based on “planar printed circuit technology” described in detail below, and then is laminated onto the curved plate 32. As described below, upper and lower conductive grids and wire leads of the membrane switch 34 are respectively made by the planar printed circuit technology, then the upper and lower conductive grids are subjected to uniform dispensing and laminated films are blanked, and finally the upper conductive grid, the laminated films and the lower conductive grid are sequentially stacked and post-treated to form the membrane switch 34. Finally, according to the shape of the curved plate 32 to be laminated, the membrane switch 34 is subtyped and blanked, the films of the same subtyping are double-sidedly adhered, and then one side fits into the foam of the same subtyping, and the other side is laminated in the inner side of the curved plate 32, and further, the goodness of fit between the both is relatively high, namely, the laminated membrane switch 34 has an extremely similar shape to the curved plate 32, as shown in FIG. 3. The subtyping technology as described in detail below can further improve the duty ratio of the pressure-sensitive surface and reduce the area of the pressure-sensitive blind zone. In an embodiment, the membrane switch 34 is capable of sensing pressure applied to most of the curved plate and exceeding a threshold value.

When the pressure 40 exceeding the threshold value is applied to the curved plate, the plate 32 deforms, and this deformation is transferred to the membrane switch to cause a local deformation. For example, the upper grid membrane and the lower grid membrane 34A and 34B of the membrane switch are squeezed to deform correspondingly, whereby the impedance of the upper grid and the impedance of the lower gild of the grid membranes or the impedance between the grids are changed (specific principles are described in combination with, for example, FIG. 2). A component 34C (for example, a support formed by squeegee) between the upper grid membrane and the lower grid membrane 34A and 34B plays a supporting role before and after the deformation of the upper and lower grid membranes. For example, before the application of pressure, the component 34C keeps the upper grid membrane and the lower grid membrane 34A and 34B substantially parallel (not shown); after the application of pressure, the component 34C makes the upper grid membrane and the lower grid membrane 34A and 34B to exhibit the shape as shown in FIG. 3, for example, some of the wires are shorting.

A sensing signal representing the sensed impedance change is transferred to a motion control system such as a computer or a microprocessor by the change in impedance of the upper and lower grids or the change in impedance between the grids through an apparatus (for example, wires (not shown)) interrelated with a sensing chip. The skilled person is aware of how to install the sensing Chip, how to sense the change in impedance of grids by the properly installed sensing chip, and how to convert the change in impedance into a corresponding electrical signal and transfer the signal to the motion control system, so these are not described in more detail.

Next, the motion control system receives, stores, and analyzes the sensing signal, and then determines whether the curved plate of the curved surface shaped membrane pressure sensor 30 is acted by a pressure that may damage the object being detected according to a processor in or outside the control system, and controls the moving state of the moving member based on said determination in some specific case, so as to avoid damage on the object being detected. For example, when the motion control system judges that the sensing signal exceeds a predetermined or customized threshold value, a command is issued to stop the motion (for example, breaking) of the moving member or to move the moving member from the current position for a certain distance in an opposite direction. In an embodiment, the motion control system and/or moving member can further issue an alarm, such as an audio alarm and a visual alarm, to indicate that the moving member and the object being detected are in contact with each other and the pressure exceeds a certain threshold value.

In an embodiment, foam 36 may be added between the cutting board shell 38 of the moving member and the lower grid membrane 34A of the membrane switch 34 to form a foam layer. The foam layer, for example, includes a subtype foam pad, which can effectively improve the strength of the membrane switch 34, effectively envelope the curved surface shaped membrane pressure sensor 30, and/or effectively ease the local deformation and squeezing caused by assembling/forming the curved surface shaped membrane pressure sensor 30 to the moving member to increase yield. Meanwhile, the foam layer can further effectively transfer the outside pressure to the shell of the curved surface shaped membrane pressure sensor for further increasing the pressure sensitivity.

The manufacturing process of a curved surface shaped membrane pressure sensor according to an embodiment is described in combination with FIG. 4 with reference to FIGS. 1-3. The key of the manufacturing process is how to combine the planar printed circuit board technology and curved plate manufacturing technology together the present application utilizes the subtyping technology as a bridge for combining said two technologies.

According to an embodiment, there is provided a method 100 for manufacturing a curved surface shaped membrane pressure sensor device (for example, curved surface shaped membrane pressure sensors 12, 30). In short, for manufacturing a curved surface shaped membrane pressure sensor device, a curved plate, a plane membrane switch to be laminated onto the curved plate, and a foam pad are mainly required. They are assembled in the manner described hereinafter, and are then mounted to a shell cutting board of a moving member for proper operation, thereby achieving the above-mentioned and other technical purposes.

Specifically, the processing of one branch of the method 100 begins at step 102. In this step, a plane membrane switch is manufactured, that is, a multi-layer flexible circuit board in the structure of sandwich is manufactured in a way in a general flat printing technology, for example, selecting a suitable flexible circuit board material according to the practical application, processing a signal layer in the structure of fine girds as shown in FIG. 2, coating or laminating an insulating rubber material and then laminating the layers in a sandwich fashion to make the respective signal layers have uniform air gaps therebetween, and finally conducting a curing treatment to make a plane membrane switch.

The processing of the other branch of the method begins at step 104 in which the thickness and/or materials of the curved plate 32 are selected according to requirements on pressure sensibility of the critical parts on the curved surface of the moving member, so as to ensure that the curved plate is subjected to a desired deformation when receiving a certain external force. Additionally, the curved plate 32 manufactured in step 104 shall also meet the requirements on appearance design, which can be carried out by the method for machining a plate machine. Further, it is allowable to select suitable materials to build the plate 32 to attain a certain protective effect, for example, waterproofing, fireproofing and so on.

Returning now to step 102, after this step, the plane membrane switch formed in step 102 is subtyped and cut (step 106) according to the curved shape (i.e., the curved shape of the curved plate 32 or the moving member) to be laminated so as to obtain a good lamination of the curved surface, thereby improving the appearance and sensing sensibility. Then the cut plates are interrelated by means of pressure welding, shorting or the like and are double-sidedly coated with rubber.

Next, in step 108, the rubber adhered surface of the membrane switch obtained in step 106 is laminated onto the curved plate formed in step 104, to form a curved surface shaped membrane pressure sensor device of the present application.

In an embodiment, the foam sheets have high deformation adaptability and are capable of enhancing mechanical strength of a membrane switch to prevent distortion and deformation during lamination or application, foam sheets 110 may be added on the membrane switch on the other side opposite the curved plate. To achieve the purpose of the present invention, the foam sheets need to be properly subtyped and cut, and then to be laminated to the subtyped and cut plane membrane switch correspondingly.

Finally, the curved surface shaped membrane pressure sensor 30 manufactured in steps 102-110 is coupled or mounted to the cutting board shell 38 of the moving member for sensing.

Persons skilled in the art could readily conceive of, in accordance with needs, installing the membrane switch or the curved surface shaped membrane pressure sensor 30 disclosed by the present application at any position on the outer surface of the moving member which would be easily touched by the object being detected, so as to achieve the following technical purposes: meeting the requirements on appearance of the outer surface of the moving member, and effectively sensing the touching to prevent injury on the object being detected, and further achieving additional effects such as fireproofing and waterproofing. The moving members include, but are not limited to, some moving members of the CT products developed by General Electric Company.

Although only a limited number of embodiments are described in detail for setting forth the present application, it is easy to understand that the present application is not limited to the disclosed embodiments. More precisely, the present application can be modified to incorporate any number of changes, alterations, substitutions or equivalent arrangements not described above but within the spirit and scope of the present application. In addition, although various embodiments of the present application are described, it is to be understood that the aspects of the present application may include only some of the described embodiments. Accordingly, the present application is not limited by the above description, but only by the scope of the appended claims.

What is claimed is:

1. A curved surface shaped membrane pressure sensor for a moving member, the curved surface shaped membrane pressure sensor comprising:
an elastic curved plate; and
a subtype grid membrane switch formed on the curved plate, which switch is coupled to a cutting board shell of the moving member on one side opposed to the curved plate,
wherein the subtype grid membrane switch is used for sensing the presence of pressure on the curved plate.

2. The curved surface shaped membrane pressure sensor according to claim 1, wherein the subtype grid membrane switch comprises an upper grid membrane and a lower grid membrane, and sensing is based on a change in grid impedance of the upper grid membrane and the lower grid membrane.

3. The curved surface shaped membrane pressure sensor according to claim 1, further comprising a subtype foam pad, and the cutting board shell is coupled to the subtype grid membrane switch through the subtype foam pad.

4. The curved surface shaped membrane pressure sensor according to claim 1, wherein a sensibility of the sensing is changed based on the material and/or thickness of the curved plate.

5. The curved surface shaped membrane pressure sensor according to claim 1, wherein motion of the moving member is controlled based on the sensing.

6. A method for forming a curved surface shaped membrane pressure sensor on a moving member, the method comprising:
forming an elastic curved plate based on a method for machining a plate;
forming a subtype grid membrane switch on the curved plate by using subtyping technologies and flat printing technology; and
coupling the subtype grid membrane switch to a cutting board shell of the moving member on one side opposed to the curved plate,
wherein the subtype grid membrane switch is used for sensing the presence of pressure on the curved plate.

7. The method according to claim 6, wherein the subtype grid membrane switch comprises an upper grid membrane and a lower grid membrane, and sensing is based on a change in grid impedance of the upper grid membrane and the lower grid membrane.

8. The method according to claim 6, wherein the cutting board shell is coupled to the subtype grid membrane switch through a subtype foam pad.

9. The method according to claim 6, wherein a sensibility of the sensing is changed based on the material and/or thickness of the curved plate.

10. The method according to claim 6, wherein motion of the moving member is controlled based on the sensing.
